(19) United States
(12) Patent Application Publication
(10) Pub. No.: US 2013/0091581 A1
(43) Pub. Date: Apr. 11, 2013

(54) Methods and Systems for Establishing and Maintaining Verified Anonymity in Online Environments

(71) Applicant: Karim PIRANI, San Diego, CA (US)

(72) Inventor: Karim PIRANI, San Diego, CA (US)

(21) Appl. No.: 13/418,033

(22) Filed: Mar. 12, 2012

Related U.S. Application Data
(60) Provisional application No. 61/603,184, filed on Feb. 24, 2012.
(60) Provisional application No. 61/545,459, filed on Oct. 10, 2011.

(51) Int. Cl. G06F 21/00; G06F 7/04

(52) U.S. Cl. 726/26

(57) ABSTRACT

In online communities and e-commerce sites that desire identity verification of individuals, a verified user is restricted to a single user identity, typically the user's real name. The use of one's real name in the context of online transactions and communication, however, is often not ideal, and in some instances, may present a safety risk for the individual. Further, specific transactions may require privacy. This invention provides methods and systems that allow an online user to establish and maintain verified anonymity. To accomplish this, a user's real identity is first verified, after which s/he establishes one or more pseudonyms each associated with the user's account, which the user may select to for use in the online environment, for example, an online social network.

### RELATED APPLICATIONS

This application claims the benefit of and priority to commonly owned U.S. provisional patent application Ser. Nos. 61/545,459, filed 7 Oct. 2011, and 61/603,184, filed 24 Feb. 2012, each of which is herein incorporated by reference in its entirety for any and all purposes.

### FIELD OF THE INVENTION

The present invention concerns online computer networks, particularly methods and systems that provide identity verification for users.

### BACKGROUND OF THE INVENTION

### Background

Online communities increasingly rely on identity verification to reduce the risk of fraud and misrepresentation. Online communities, including social networking websites and e-commerce websites, are more susceptible to fraud resulting from users hiding behind anonymous identities. Without accountability, anonymous users with bad intentions can take advantage of innocent users with very little or no consequences.

Verifying a user's identity creates accountability since a verified user's actions can likely be traced using the personal identifying information provided by the user. As a result, today systems that require the use of verified identity typically require users to use their real names in representing themselves. Compelling users to use their real names or true identities, however, can be problematic in some contexts, particularly when privacy is desired. Indeed, in some cases the use of real names can result in dangerous situations.

This invention addresses the need for accountability on the course of online activity while at the same time allowing a user to remain anonymous while participating in online communities and marketplaces, if the user chooses to do so or if the particular online environment requires anonymity. This is accomplished by associating a user's single verified identity with one or more pseudonyms that the user can use to communicate or transact with other users. This allows the benefits of anonymity to be applied to situations where privacy is desired, while at the same time maintaining the accountability needed to ensure a safe community.

### DEFINITIONS

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

Items of information or data “associated with” a user refers to information or data specific to or provided by the user, typically as part of an account registration process or through use of the particular computer network. Such information or data is stored in the network and is associated with the particular user. For example, a unique pseudonym selected by the user for use in communicating with others in the online environment or network may be “associated with” or registered to that user.

An “online environment” or “online network” refers to any network of interconnected computers. Online environments or networks include social networks such as Facebook® and MySpace®, as well commercial networks such as eBay® (owned and operated by eBay, Inc.) and Amazon® (owned and operated by Amazon.com, Inc.). Online environments are sometimes also referred to as “online communities”.

A “plurality” means more than one.

### SUMMARY OF THE INVENTION

The object of the invention concerns methods and systems that provide verified anonymity for users in an online environment (e.g., an online social network), where “verified anonymity” means that a registered user whose real identity has been verified can communicate or transact business online with others in the online community using one or more pseudonyms selected by the user and associated with his/her user account in the online environment. In this way the user can maintain anonymity in communicating in the online environment in a way that also provides accountability.

Thus, one aspect of the invention relates to methods for creating verified anonymity in an online environment, for example, an online social network or online marketplace. This is accomplished by allowing a registered user of an online environment having a user account and a verified identity to establish and store in association with the user's account at least one user representation, for example, a pseudonym, for use in online communication with one or more other users in the online environment. Preferably, any user representation (e.g., one or more pseudonyms) selected by a user will be unique within the particular online environment (i.e., be a unique user representation).

In the context of the invention, a verified identity of a registered user of an online environment is established by a verification process that involves verifying the accuracy of at least one item of personal identity information provided by the user during a registration process, preferably at the time an individual registers as a user of the online environment, at which time the online environment's network system establishes a user account for the user. Items of personal identity information may include an individual's full name, her/his residence address, telephone number(s), credit card account number(s), social security number, state and driver's license number, passport number, birth date and/or age, gender, as well as biometric information obtained from the user, including one or more finger prints, facial photographs, iris print, etc. Such personal identity information is stored on the system in the user's account, as is any pseudonym established by the user.

Identity validation or verification confirms that the individual registering to use the online environment is who s/he purports to be. Identity verification can include confirmation that data entered by the user during an account registration or updating process is accurate. Identity verification can be performed by any suitable method, including in an automated format at the time of user registration (when the user's account is established, or at any time when a user's account information is updated), by a third party vendor, etc. Validation or verification can, for example, also include obtaining the user's credit history report(s), conducting a criminal background check, etc. After validating the user's identity to the degree desired or required, the system updates the user's identity record (or account) accordingly.

Another aspect of the invention concerns online environments that employ verified anonymity for one or more users. Such online environments include online social networks and online marketplaces.

These and other aspects and embodiments of the invention will become more apparent from the following detailed description, accompanying drawings, and the claims.

### BRIEF DESCRIPTION OF THE DRAWINGS

FIGS. 1 and 2 are flowcharts illustrating two representative processes by which a user can register to use a particular online environment and by which the system controlling the online environment particular verifies the user's identity as part of the registration process.

FIG. 3 is a flowchart illustrating a representative process by which a user posting a new ad listing in an online marketplace can select from among the user's real name or multiple pseudonyms (a preferred form of unique user representation) that are registered to or associated with that user.

FIG. 4 is a flowchart illustrating a representative advertisement-based transaction process between a pseudonym user with verified identity status and a user who has posted an ad listing in the particular online environment.

### DETAILED DESCRIPTION OF THE INVENTION

In online communities and e-commerce sites that desire identity verification of individuals, a verified user is restricted to a single user identity, typically the user's real name. Using one's real name in the context of online transactions and communication, however, is often not ideal, and in some instances, may present a safety risk for the individual. Further, specific transactions or communications may be promoted by or require privacy or anonymity. This invention provides methods and systems that allow an online user to establish and maintain verified anonymity for use in the particular online community. To accomplish this, a user's real identity associated with her/his user account is verified. He or she also selects one or more unique pseudonyms or other unique user representations (e.g., avatars) or a unique combination of user representations (e.g., a pseudonym and an avatar, a pseudonym and a tone or music sample, etc.) sufficient in the system to uniquely but anonymously identify the user), each of which is associated with the user's account, which the user may select to for use in the online environment, for example, an online social network. Indeed, the methods and systems of the invention envision a registered user repeatedly using a pseudonym (or other unique representation) repeatedly or only once, as the user desires.

As will be appreciated, the online environments of the invention are systems and methods that are implemented on any suitable computer network capable of serving a plurality (hundreds, thousands, and even millions) of users. A provider operates and maintains the computer network and database(s) that provides the particular online environment (e.g., a social networking website, an e-commerce website, etc.). Often, the provider hosts a website that makes the online environment available to users via the Internet. Users can connect to a particular online environment via any suitable device, including personal computers, computer terminals, cellular phones, smart phones, personal digital assistants, web-enabled electronic reading devices, web-enabled televisions, etc. It is well within the skill of those in the art to implement the instant invention on any suitable computer network. Generally, such computer networks are comprised of networked servers that comprise microprocessors, memories, software, and databases, including databases that store user profiles and such other data as the system may require to operate as intended. Detailed descriptions of several representative, preferred embodiments of the invention are described below.

### Preferred Embodiments Shown in the Drawings

Several representative preferred embodiments of the invention are shown in the figures. The following description further elucidates those embodiments.

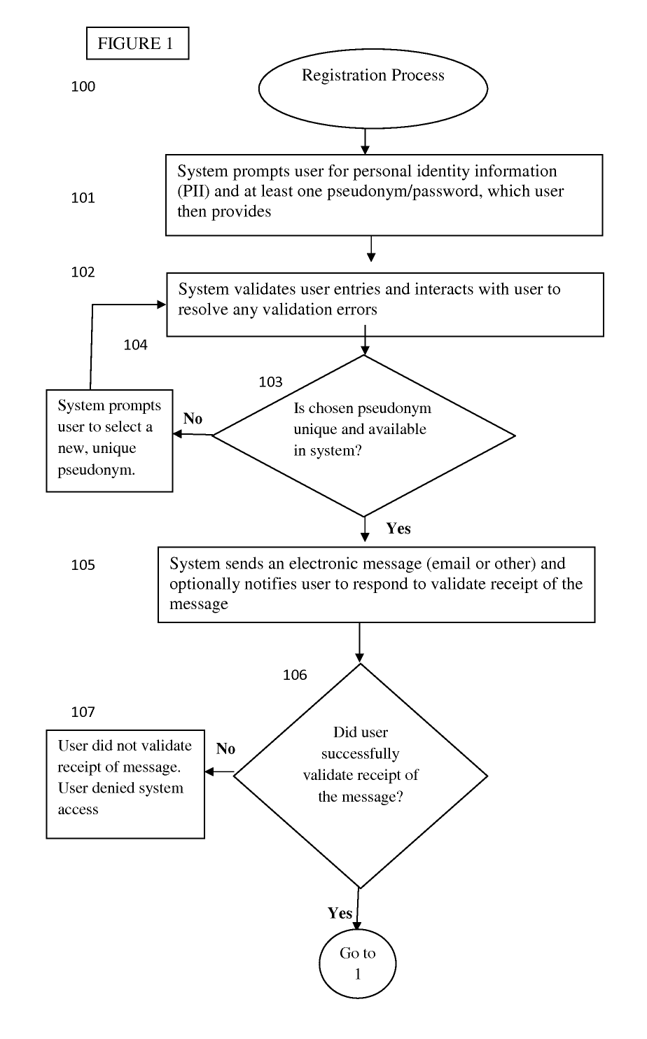

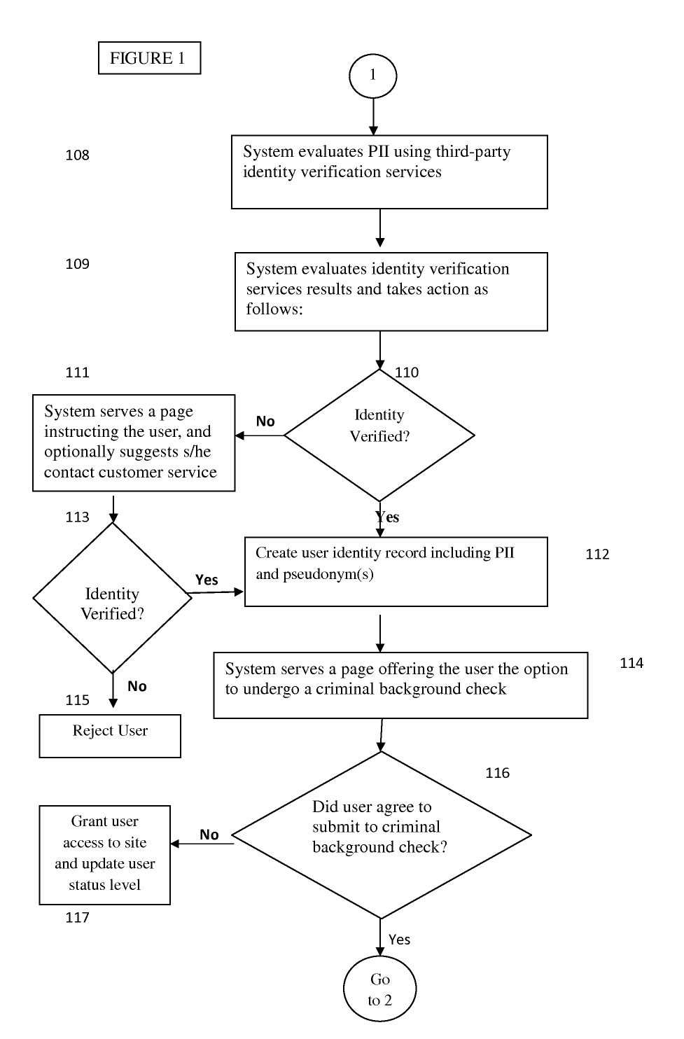

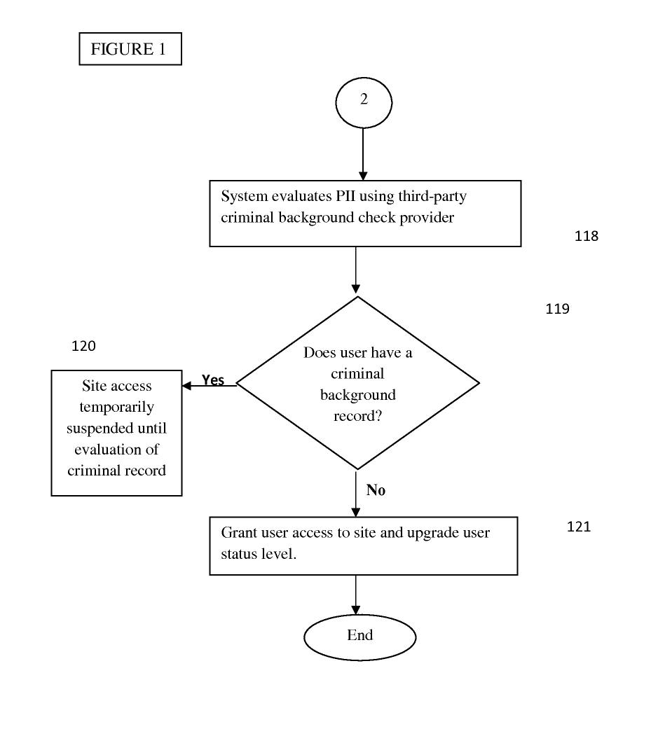

FIG. 1 is a flowchart that illustrates how a user registers (100) to use an online environment according to the invention; i.e., that requires identity verification for users wishing to employ one or more pseudonyms when communicating, transacting, or otherwise interacting with other users of the particular online environment. As part of this registration process (100), the system verifies the user's identity to be consistent with the personal identity information or data (PII) supplied by the user (101) during the registration process.

In a preferred embodiment, after a user calls up the online network s/he wishes to register to use, for example, by entering the appropriate website, the system that controls the online environment prompts the user to provide personal identity information, for example, the user's real or true full name, her/his residence address, email address(es), telephone number(s), credit card account number(s), social security number, state and driver's license number, passport number, birth date and/or age, gender, as well as biometric information obtained from the user, including one or more finger prints, facial photographs, iris print, etc. Such personal identity information is stored on the system in the user's account, as is any pseudonym established by the user. As will be appreciated, some of the requested PII may be required by to register as a user of the online environment, while other information may be optional, in that it may be requested but is not necessary for registration. The distinction between required and optional information is often clearly designated in the data entry field for the item of PII.

After the user has entered the requested data, or some portion of it, the system preferably validates whether at least the required information has been provided. If not, the system prompts the user to complete the necessary data field(s).

As part of the registration process, or after an earlier session in which an individual has successfully provided sufficient PII to create a user account stored in the online environment's system so as allow the user to login, the user is prompted to create or establish a pseudonym for subsequent use on the system (102). As it is preferred that any pseudonym used on a particular online environment be unique in that environment, the system checks to determine if the pseudonym is unique and thus available (103) in the system. The system may also apply a set of rules to determine if a proposed pseudonym, even if unique, is acceptable for use in the system. For example, pseudonyms containing profanity or other potentially inflammatory, derisive, or derogatory language or terminology may be rejected as unacceptable for use on the system.

If a user proposes a pseudonym that is unique and available for use on the system, the user is so notified (105), which notification may also optionally include a request that the user respond to validate receipt of the message. Further confirmation ensures that the registering user has access to the electronic communication (email or mobile phone) registered to that individual. Once a pseudonym is verified by the system to be unique and available within the system, the approved pseudonym will be uniquely tied to that user's account. If desired, the system may allow the user to select one or more additional pseudonyms at this or a later stage, each of which will also be similarly evaluated and, if unique and available, will also be registered to that user.

If the pseudonym that is assessed is rejected for whatever reason(s), the user is notified that the pseudonym is not available and prompted to enter a different pseudonym. The prompt may also provide, or direct the user to another page containing, rules and guidelines governing pseudonym types and usage on the system.

If the user successfully validates receipt of the message (106), the system then evaluates the user's PII to determine its accuracy (108). This verification process may be performed in an automated fashion by the system, for example, by making an electronic inquiry to a financial institution to determine if credit card information provided by the user is accurate. The process may also be performed by a third party verification service, or by any other automated, semi-automated, or manual process suited to determine the accuracy of the user-supplied information. If the user does not successfully validate receipt of the message (106), the user is denied access to the system unless and until s/he completes the registration process.

After a user's PII is verified, the system creates a user identity record that includes the user's PII and pseudonym(s) (112). At this stage the user becomes a registered user, and becomes entitled to access as least some portion of the online environment's functionality. If the user's PII is not verified, the user is so notified and prompted to contact the system's customer service division for assistance if the individual still desires to register to use the online environment (111).

After becoming a registered user, in some embodiments, the system may prompt the user as to whether s/he wishes to obtain further identity verification, as may be necessary to access certain portions of a particular online environment. Further verification may include an examination of a user's credit history, educational background, marriage status, criminal history, employment history, professional credentials, etc. FIG. 1 further illustrates as part of its process the conduct of a criminal background check of user (116). If the user agrees to such a check, depending upon the particular system, either before or, preferably, after completing the criminal background check the user's status is upgraded (117) or upgraded pending results of the evaluation. Alternatively, the user's status may remain unchanged, pending receipt of the results of the criminal background check, which may be performed by a third party vendor retained for such purpose or by the system using a suitable routine. If the user is found to not have a criminal record, her/his status is updated to reflect that finding (121). On the other hand, if the user is found to have a criminal record, the status of her/his account may or may not be upgraded, and in some cases, the user's access to the system may be suspended pending further consideration (120).

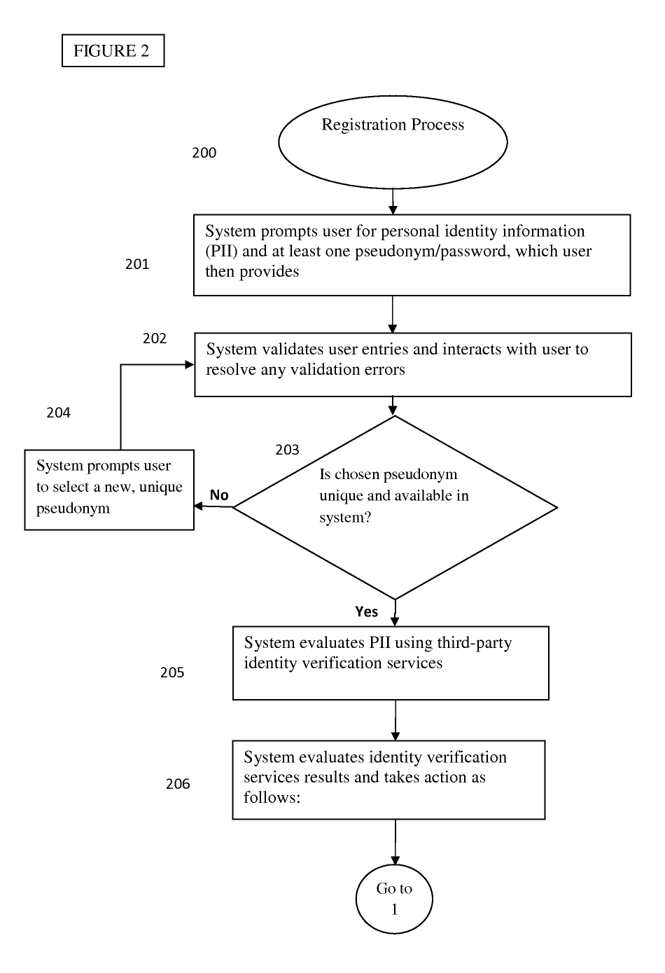

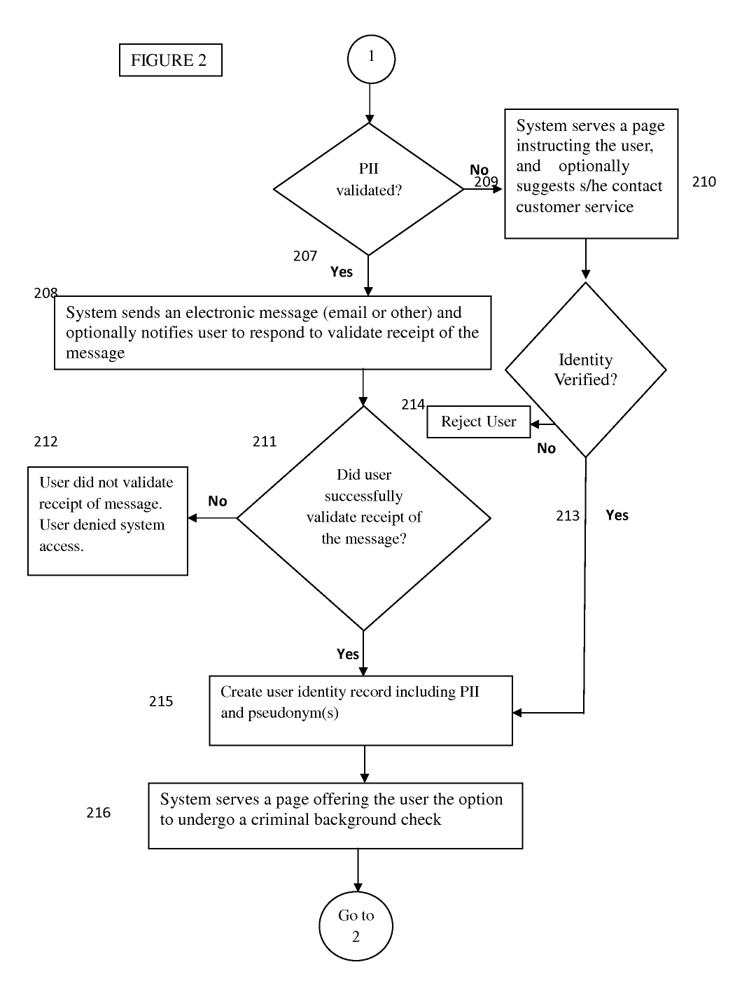

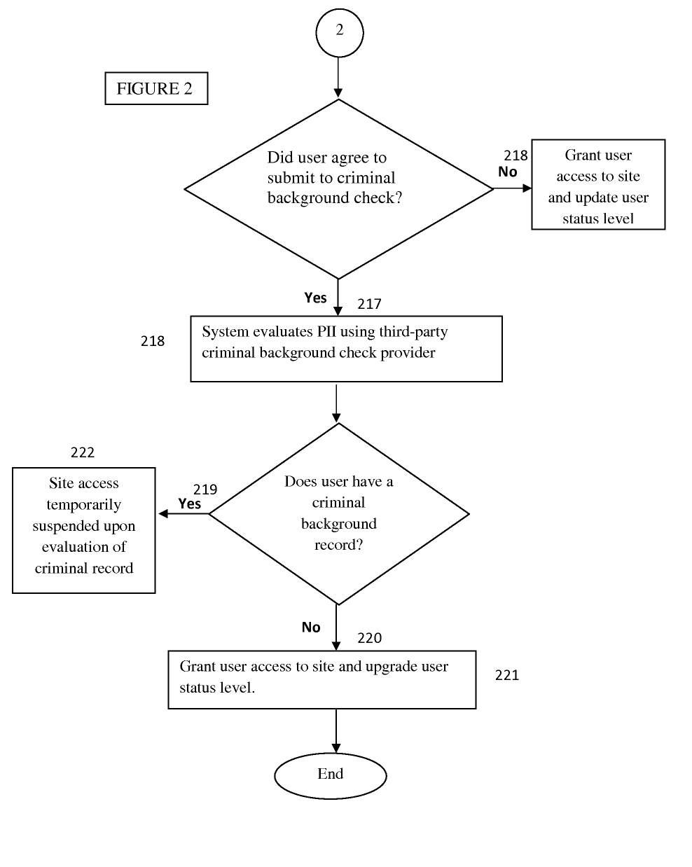

FIG. 2 is a flowchart that illustrates another example of how a user can register to use an online environment according to the invention; i.e., that requires identity verification for users wishing to employ one or more pseudonyms when communicating, transacting, or otherwise interacting with other users of the particular online environment. As part of the registration process (200) shown in this Figure, if the system verifies the user's identity to be consistent with the personal identity information or data (PII) supplied by the user (201) during the registration process, as also occurs in the embodiment illustrated by the flowchart in FIG. 1.

In this embodiment, after a user calls up the online network s/he wishes to register to use, for example, by entering the appropriate website, the system that controls the online environment prompts the user to provide personal identity information, for example, the user's real or true full name, her/his residence address, email address(es), telephone number(s), credit card account number(s), social security number, state and driver's license number, passport number, birth date and/or age, gender, as well as biometric information obtained from the user, including one or more finger prints, facial photographs, iris print, etc. Such personal identity information is stored on the system in the user's account, as is any pseudonym established by the user. As will be appreciated, some of the requested PII may be required to register as a user of the online environment, while other information may be optional, in that it may be requested but is not necessary for registration. The distinction between required and optional information is often clearly designated in the data entry field for the item of PII.

After the user has entered the requested data, or some portion of it, the system preferably validates whether the user has provided at least the required information (202), which may be less than all of the information the system prompts the user to provide. If not, the system prompts the user to complete the necessary data field(s).

As part of the registration process, or after an earlier session in which an individual has successfully provided sufficient PII to create a user account stored in the online environment's system so as allow the user to login (as may be the case in updating an existing online environment and system to include verified identity functionality), the user is prompted to create or establish a pseudonym for subsequent use on the system (203). As it is preferred that any pseudonym used on a particular online environment be unique in that environment, the system checks to determine if the pseudonym is unique and thus available (204) in the system.

The system may also apply a set of rules to determine if a proposed pseudonym, even if unique, is acceptable for use in the system. For example, pseudonyms containing profanity or other potentially inflammatory, derisive, or derogatory language or terminology may be rejected as unacceptable for use in the online environment controlled by the system.

Once a pseudonym is verified by the system to be unique and available within the system, the approved pseudonym will be uniquely tied to that user's account. Depending upon the particular embodiment, a pseudonym approved for use by one user may be released for subsequent use by another user in the event the user account associated with the user who initially registered the pseudonym is closed, suspended, or otherwise disabled.

If desired, the system may allow the user to select one or more additional pseudonyms at this or a later stage, each of which will also be similarly evaluated and, if unique and available, will also be registered to that user. If the pseudonym that is assessed is rejected for whatever reason(s), the user is notified that the pseudonym is not available and prompted to enter a different pseudonym. The prompt may also provide, or direct the user to another page containing, rules and guidelines governing pseudonym types and usage on the system.

While not shown in the FIG. 2, any system according to the invention may also provide functionality to evaluate the uniqueness of a pseudonym proposed by a user. Uniqueness can be assessed, for example, by adapting an algorithm for evaluating password strength to determine how unique the proposed pseudonym is. Those results may be presented to the user, and depending on the degree of uniqueness, the user may opt to use the pseudonym or create a new one, in which event the routine for pseudonym evaluation iterates. If desired, as part of the pseudonym development process the system may also be configured to suggest one or more pseudonyms to the user, preferably based on user input.

If a user proposes a pseudonym that is unique and available for use on the system, the system proceeds to obtain validation of the user's PII, preferably by using a third party vendor that provides identity verification services (205). Following its PII evaluation, the third party vendor provides the results of its analysis to the system, and the system then evaluates those results (206). If the system determines that the user's PII has been validated (207; for example, by the third party confirming to the system the accuracy of each item of the user's PII), the system communicates with the user (e.g., by email, text message, automated phone call, etc.) (208), and may optionally request (or require) that the user respond to validate receipt of the message. Further confirmation ensures that the registering user has access to the electronic communication medium (e.g., email, mobile phone, etc.) registered to that individual. If the user successfully validates receipt of the message (211), the system establishes a permanent user identity record for that user (215), which identity record (or user account) includes the user's PII and pseudonym(s) and such other information as the system is configured to collect, save, and maintain. Should the user not validate receipt of the message, s/he is denied access to the online environment until the user validates the message or otherwise completes the registration process. In some embodiments, should the user not validate receipt of the message, for example, by failing to respond to the system's electronic message, failing to respond within a system-defined time period, etc., the system may attempt to further communicate with the user, for example, by sending the user an email or text message, to prompt the user to complete the registration process, contact customer service, etc.

If the user's PII is not validated, the user is denied access to the system unless and until s/he completes the registration process. In this embodiment, in the event that a user's PII has not been validated (209), the system so notifies the user (210) (here, by serving a page to the user, although any form of contact can be used), and preferably suggests that the user contact the system's customer service unit for further assistance. If the user's PII is then subsequently verified (e.g., based on user interaction with the system's customer service unit) (213), the system establishes a permanent user identity record for that user (215), which identity record (or user account) includes the user's PII and pseudonym(s) and such other information as the system is configured to collect, save, and maintain. If the user's PII is not subsequently validated (214), the user is denied access to the online environment unless and until s/he otherwise completes the registration process.

At the stage the system creates a permanent user identity record that includes the user's PII and pseudonym(s) (215), the user becomes a registered user, and becomes entitled to access at least some portion of the online environment's functionality. After becoming a registered user, in some embodiments, the system may prompt the user as to whether s/he wishes to obtain further identity verification, as may be necessary to access certain portions of a particular online environment. Further verification may include an examination of a user's credit history, educational background, marriage status, criminal history, employment history, professional credentials, etc. FIG. 2 further illustrates as part of some embodiments of the invention, the process can further include the conduct of a criminal background check of user (216). If the user agrees to such a check (217), depending upon the particular system, either before or, preferably, after completing the criminal background check the user's status may be modified or upgraded pending results of the evaluation. Alternatively, the user's status may remain unchanged, pending receipt of the results of the criminal background check, which may be performed by a third party vendor retained for such purpose (218) or by the system using a suitable routine. If the user is found to not have a criminal record (220), her/his status is updated to reflect that finding (221) and, depending on the particular embodiment, the user may be granted access to portions of the online environment access to which is restricted to only those users who have obtained the necessary status. On the other hand, if the user is found to have a criminal record, (219), the status of her/his account may or may not be upgraded, and in some cases, the user's access to the system may be suspended pending further consideration (222).

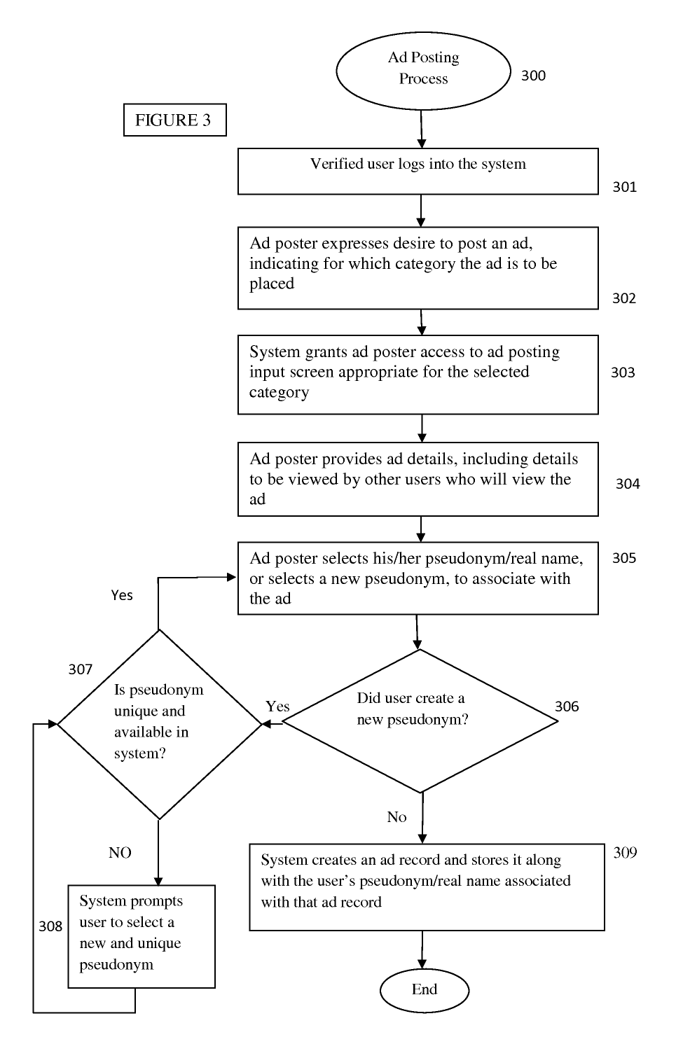

FIG. 3 is a flowchart illustrating the process by which a user can post a new advertisement listing in an online marketplace (300). To begin, registered user logs into the system (301). The user expresses a desire to post an advertisement by selecting an ad category (302). The system then grants the user access to an ad-posting screen for data entry for the selected ad category (303). The user then posts the details for the particular ad to be generated, including details to be viewed by other users (304). Depending on the particular system, some or all of users viewing the ad may also have verified anonymity in the particular online environment, allowing them to transact business in using one or more of her/his registered pseudonyms. Whether applicable law allows users and ad posters to enter into legally binding contracts using pseudonyms will depend on the law of the jurisdiction(s) governing the particular transaction. In those jurisdictions that allow transactions where both buyers and sellers use pseudonyms, both the ad poster and prospective buyer may opt to use her/his registered pseudonym, or create a new pseudonym associated with the particular party's account in the system for purposes of the particular transaction (305). Of course, the system preferably also includes the option for each communicating, transacting, or otherwise interacting party to select to use her/his real name registered with that user's account. If the ad poster chooses to generate a new pseudonym (306), the system checks to confirm if that pseudonym is unique and available (307). If so, the poster may then use that pseudonym in conjunction with that particular ad. If not, the system prompts the poster to select a new pseudonym (308), in which event the process iterates until the poster creates a pseudonym that is unique and available, or, alternatively, the poster opts to use an existing pseudonym already registered to that user.

The system then creates an ad record for that ad and stores it in association with the poster's user account information and transaction records (309).

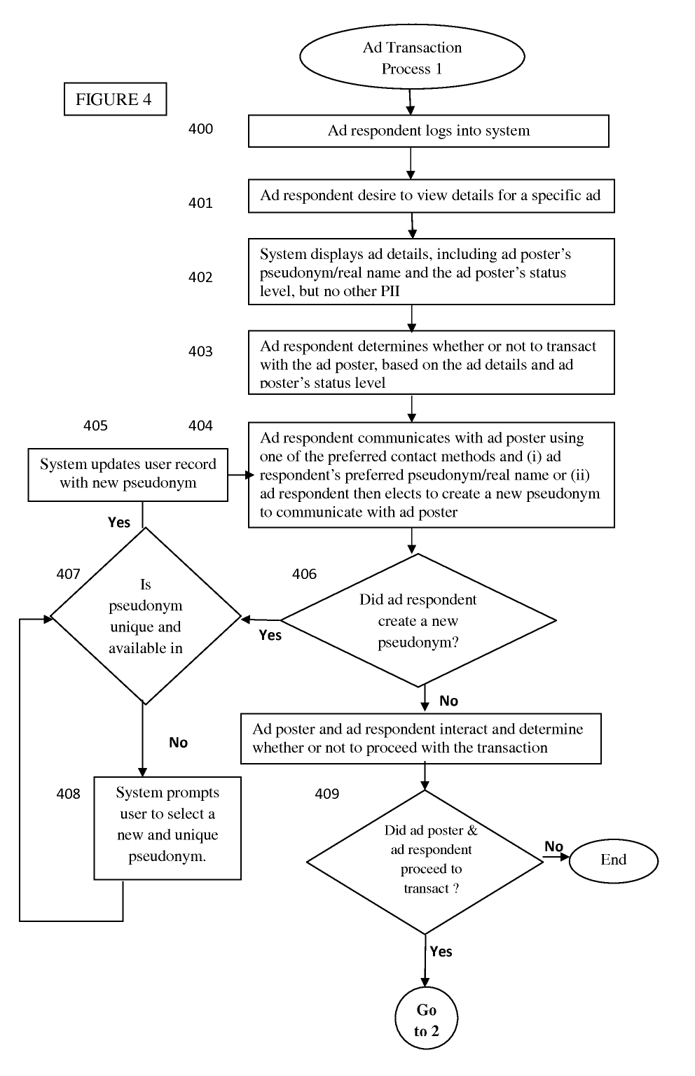

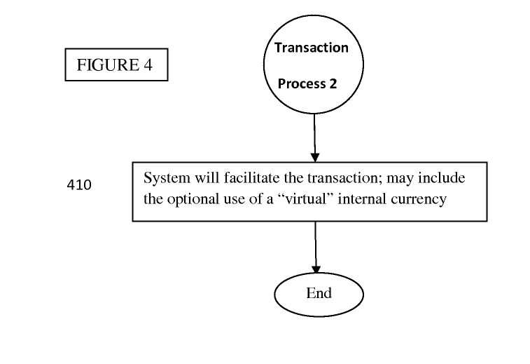

FIG. 4 is a flowchart illustrating the process by which a user with verified identity status may respond to another user's ad posting by choosing to either divulge his/her identity or maintain anonymity by using the multiple pseudonyms that are registered to that user or elect to create a brand new pseudonym that is unique within the system. In this representative process, the ad respondent logs into the system (400), or after already being logged in, chooses to visit the portion of the system devoted to posted advertisements. Upon seeing an ad of interest, the user wishes to view details specific for that ad (401). The user calls the system to display the desired ad's details, which the system then serves the user's computer for display to the user. In the embodiment shown, the displayed details may include the poster's pseudonym or real name, along with indicia indicating her/his status level (402).

The user responding to the ad then determines whether or not to transact with the ad poster, based on the ad details and ad poster's status level (403). If the respondent wishes to proceed further, s/he then communicates with the ad poster using one of the preferred contact methods using the ad respondent's preferred pseudonym (or real name, if allowed or desired) (304) or a new pseudonym created at that time by the respondent (406-408). Using a desired, registered pseudonym or her/his real name, the respondent then contacts the ad poster, and the parties decide whether to enter into a transaction (409). If so, in the embodiment shown, the system facilitates the transaction, and may include the use of a “virtual” or other currency that may exist within the particular online environment.

### Further Preferred Embodiments

The following describes a preferred, representative example of an initial user registration and identity verification process that can be used in practicing the invention.

To register as a user of an online environment, a person typically uses a browser application to navigate to the desired website. The online environment's system then prompts the person for variety of personal identity information (PII) (e.g., full name, residence address, etc.), to select and confirm a password for secure logins, and at least one pseudonym. The user enters the requested information in corresponding fields. After completing entry of the requested or required data and information, the system validates the user's entries and interacts with the user to resolve any validation errors. The system also checks to determine if the chosen pseudonym(s) are unique and available in system. If not, the system prompts the user to select a new pseudonym, and the process iterates until the user selects a pseudonym that the system determines to be unique.

After determining that the chosen pseudonym(s) is(are) unique, the system undertakes to evaluate the accuracy of the PII. Verification of some or all of a user's PII can be performed by any verification method, including online, automated methods integrated into the online environment's system, through a third party information verification vendor, or a combination of these or other methods. For example, in a preferred method, the system sends an email to the user's registered email address asking the user to initiate an automated phone call from the system to the user's registered phone number. The email also contains a numeric (or alphanumeric) validation code, an example of which is a 4-digit numeric validation code. The automated phone call may be initiated by the user, for example, in response to the user clicking on a link supplied in the email. In some embodiments the user can click on the link at any time after receiving the email; in other embodiments, the time period in which the user may respond may be limited. After initiating the call, the user's registered phone is called and an automated message instructs the user to enter the validation code supplied in the email into the phone. If the user successfully enters the correct validation code into her/his phone, the system updates the user's account status to “verified” or the like. If a third party performs the verification process, after successful verification the third party notifies the system of success in validating the user's PII, in which case the user's account status would also be updated to “verified”.

If the user does not correctly enter the validation code for whatever reason (e.g., the correct alphanumeric validation code is not entered after one or more attempts, no code is entered within the time frame for doing so, etc.), or if third party PII verification is unsuccessful, the user's account status will remain “unverified” or the like and, as a result, the user's access to the online environment is restricted or prevented, as the case may be, and if the system is so configured, the user will not be allowed to interact with other users in the particular online environment (or those portions thereof that require PII verification for access). The system may also be configured such that for a user whose account remains “unverified” after a predetermined period or after a predetermined number of verification attempts, the unverified user will be prompted (e.g., via email, via a webpage, etc.) to contact the customer service division for further assistance, for example, to receive manual verification, etc.

In an alternative embodiment of an identity verification process suitable for use in the context of the invention, the system sends a user's PII (or a portion thereof) to a secondary third party vendor for verification. During the period of third party evaluation the user's account status remains “unverified”, “pending verification”, or the like. In this embodiment, the third-party vendor returns a series of questions to the user based on the personal date of the user transmitted to the third party. Preferably, the system serves the user a page requesting the user to answer the series of personal questions returned from the third party service. If the user successfully answers the questions (or some pre-defined subset or number of them) correctly, the system updates the user's status to “verified” or the like. If, however, the user does not successfully answer the questions (or some pre-defined subset or number of them) correctly, the system does not update the user status, which remains “unverified”, “pending verification”, or the like. As a result, the user's access to the online environment will be restricted or prevented, as the case may be, and if the system is so configured, the user will not be allowed to interact with other users in the particular online environment (or those portions thereof that require PII verification for access). Again, the system may also be configured such that for a user whose account remains “unverified” after a predetermined period or after a predetermined number of verification attempts, the unverified user will be prompted (e.g., via email, via a webpage, etc.) to contact the customer service division for further assistance, for example, to receive manual verification, etc.

An example of a manual identity verification process is as follows: after a user has completed registration but has been unable to have her/his identity successfully verified, the user is instructed to contact the system's customer service division for further assistance to receive manual verification over the telephone. The customer service representative asks the user to provide a copy of one or more forms of personal identification that can be used to validate the user's identity. Examples include a legible copy of a state-issued form of identification, including a driver's license, passport, state-issued identification card, immigration visa, birth certificate, as well as any other documentation that can be used to confirm, validate, or otherwise verify the user's identity. For example, a recent telephone bill could be used for this purpose, whereby a user would forward a copy of a recent telephone bill to the customer service representative, who could then call the user at the telephone number listed on the phone bill. As will be appreciated, a telephone bill could also be used to confirm other information about a user that a particular system might request, including address information. In any event, if the user successfully supplies sufficient personal documentation to verify her/his identity, the system is updated to reflect the user's status as “verified” or the like. If the documentation submitted is inconsistent with existing PII or is otherwise still insufficient to verify the user's identity, the system will not update the user status to “verified”; instead, the user's status will remain “unverified”, “verification failed”, or the like.

If desired, the system may display in conjunction with a user's name, which preferably will be her/his system pseudonym (or one of several the user may have on the system), indicia reflective of the level of verification achieved for that user (or for that pseudonym). For example, the system may be configured such that a user whose PII entered at the time of registration (or subsequently confirmed) has been validated is indicated as having “Silver” status. More extensive degrees of verification may be indicated by other indicia. For example, a user whose PII and credit history have been evaluated may be assigned a different status, for example, “Gold” status, whereas such a user who has also successfully completed a system-initiated criminal background check may be indicated as having “Platinum” verification status. Verification of other aspects of a user's life, for example, financial condition, health status, level of education, etc., may also be provided for in various embodiments of the invention.

As will be appreciated, the online environment may be configured such that access to different portions of the environment may be regulated based on the degree of user verification. For example, all users holding some minimally defined level of identity verification may be able to communicate as “friends” with other verified users using their respective pseudonyms (or real names, if desired), whereas communication with users wishing to communicate on a professional level, about romantic or sexual interests, etc., may require a different, higher level of verification (e.g., of health status, level of education, financial condition etc.)

1. A method for creating verified anonymity in an online environment, comprising allowing a registered user of an online environment having a user account and a verified identity to establish and store in association with the user's account at least one user representation, optionally a pseudonym, that uniquely but anonymously identifies the user in the online environment for use in online communication with one or more other users in the online environment, thereby creating verified anonymity.

2. The method according to claim 1 wherein the online environment is an online social network or online marketplace.

3. The method according to claim 1 wherein the representation, optionally a pseudonym, is unique within the online environment.

4. The method according to claim 1 wherein the verified identity of the registered user is established by a verification process that comprises verifying the accuracy of at least one item of personal identity information provided by the user during account registration.

5. The method according to claim 4 wherein the verification process is performed by an independent vendor.

6. The method according to claim 4 wherein the verification process includes investigating the user's credit history and/or criminal history, if any.

7. A method for creating verified anonymity in an online environment, comprising:
a. for a registered user having an online account in an online environment, verifying at least one item of personal identity information associated with the registered user's online account to verify the identity of the registered user;
b. allowing the registered user to establish and store in association with the registered user's online account at least one user representation, optionally a pseudonym, that uniquely but anonymously identifies the user in the online environment for use in online communication with one or more other users in the online environment, thereby creating verified anonymity.

8. The method according to claim 7 wherein the online environment is an online social network or online marketplace.

9. The method according to claim 7 wherein the user representation, optionally a pseudonym, is unique within the online environment.

10. The method according to claim 7 wherein the at least one item of personal identity information is selected from the group consisting of the user's real name, the user's residence or billing address, and an item of biometric data from the user.

11. The method according to claim 10 wherein the verification process is performed by an independent vendor.

12. The method according to claim 10 wherein the verification process includes investigating the user's credit history and/or criminal history, if any.

13. An online environment that comprises a plurality of users at least one of whom has verified anonymity, wherein the user's verified anonymity results from performing a method according to claim 1.
